(19) United States
(12) Patent Application Publication
(10) Pub. No.: US 2018/0076686 A1
(43) Pub. Date: Mar. 15, 2018

(54) ELECTRIC MACHINE WITH STATOR HAVING CAVITIES, FOR USE IN AN AUTOMOTIVE VEHICLE

(71) Applicant: Valeo Systemes de Controle Moteur, Cergy Saint Christophe (FR)

(72) Inventors: François Machet, Cergy Saint Christophe (FR); Yacine Ayad, Cergy Saint Christophe (FR); Samir Guerbaoui, Cergy Saint Christophe (FR); Abdou Salembere, Cergy Saint Christophe (FR)

(73) Assignee: Valeo Systemes de Controle Moteur, Cergy Saint Christophe (FR)

(21) Appl. No.: 15/527,599

(22) PCT Filed: Nov. 20, 2015
(86) PCT No.: PCT/FR2015/053153

§ 371 Date: May 17, 2017

(30) Foreign Application Priority Data
Nov. 20, 2014 (FR) 1461261

(51) Int. Cl. H02K 5/24; H02K 1/14; H02K 1/24; H02K 1/27; F02B 33/40; F04D 25/06

(52) U.S. Cl. CPC H02K 5/24; H02K 1/148; F04D 25/06; H02K 1/2753; F02B 33/40; H02K 1/246

(57) ABSTRACT

The invention relates to an electric machine (10) and, for example, a variable reluctance or permanent-magnet electric motor, for use in an automotive vehicle, in particular for an electric supercharger for automotive vehicles, comprising a rotor (12) and a stator (14) which are furnished with teeth (16; 18), the stator (12) having at least one cavity (34; 36) distinct from the space between the teeth (18) of the stator (14). The invention also relates to an electric supercharger for automotive vehicles, comprising a compression wheel and an electric machine (10) of this type, for driving the compression wheel in rotation.

The present invention relates to an electric machine, and for example a variable reluctance or permanent-magnet electric motor, for application in a motor vehicle, in particular for an electric supercharger for automotive vehicles, including such a variable reluctance or permanent-magnet electric motor.

It is known to implement an electric supercharger in an air supply circuit of a motor vehicle internal combustion engine.

Such an electric supercharger is traditionally implemented in the air intake line of a thermal combustion engine of an automotive vehicle, upstream or downstream from a supercharger. Alternatively, or additionally as described in application FR-A-2,991,725 in the Applicant's name, such a compressor can be implemented on an exhaust gas recirculation line of the internal combustion engine.

The electric supercharger traditionally includes a wheel intended to compress the air entering the compressor and an electric machine, for example a variable reluctance or permanent-magnet motor, to rotate the wheel.

Unlike superchargers, which are driven by exhaust gases, the electric supercharger, operating with such an electric machine, has a very short response time. This makes it possible to reinforce the low-end torque of the internal combustion engine, offset the response time of the supercharger, and improve the acceleration of the motor vehicle in which the internal combustion engine provided with the electric supercharger is mounted.

However, the electric machine implemented in such an electric supercharger is subject to high-amplitude vibrations due to the electromagnetic flux and force variations, which are detrimental to the comfort of the driver of the motor vehicle.

Furthermore, in particular due to the rating at which such an electric machine and for example a variable reluctance or permanent-magnet motor is used, such a compressor is noisy.

The present invention aims to propose an improved electric machine, and for example a variable reluctance or permanent-magnet electric machine, for automotive applications, in particular for an electric supercharger, not having at least some of the aforementioned drawbacks.

To that end, the invention proposes an electric machine, in particular a variable reluctance or permanent-magnet electric motor for use in an automotive vehicle, in particular for an electric supercharger for automotive vehicles, comprising a rotor and a stator provided with teeth, the stator having at least one cavity separate from the space between the teeth of the stator.

Thus, according to the invention, at least one cavity is formed in the stator of the machine, separate from the space between the stator teeth. This or these cavities make it possible to obtain a cord effect in the stator, which makes it possible to adapt the sound waves created in the motor.

Furthermore, these cavities make it possible to modify the rigidity of the stator, and consequently, to modify the frequencies of the noise emitted by the motor, in particular toward lower frequencies that are generally perceived as less disagreeable to users.

According to different embodiments, which may be considered together or separately:
the stator has at least one cavity emerging, preferably only, at one or both ends of the stator;
the stator comprises at least one cavity emerging on the radially outer surface of the stator, preferably in the form of a groove formed in the radially outer surface of the stator;
the stator comprises at least one cavity on a profile of a tooth of the stator, preferably in the form of a groove formed in the profile surface of the tooth of the stator;
the stator is received in a case of the machine while leaving free spaces between the stator and the case, the free spaces extending essentially along a longitudinal direction of the stator, the stator and the case of the machine preferably defining linear contact zones;
the stator has, in cross-section, a generally polygonal enclosure having, if applicable, one or several cutouts formed by at least one cavity emerging on the radially outer surface of the stator, and preferably, rounded corners intended to be in contact with the case of the machine, if applicable;
the case of the machine forms a housing for receiving the stator that is generally circular in cross-section;
cavities extending essentially along the longitudinal direction of the rotor are formed in the teeth of the rotor; and
the teeth of the stator and/or the teeth of the rotor have, in cross-section, bevels preferably forming an angle greater than 1°, preferably greater than 3°, and less than 10°, still more preferably less than 7°.

According to another aspect, the invention relates to an electric supercharger for an automotive vehicle, including a compression wheel and an electric machine, in particular a variable reluctance or permanent-magnet electric motor as described above, in all combinations, to rotate the compression wheel.

The appended figures will clearly show how the invention can be carried out, in which:

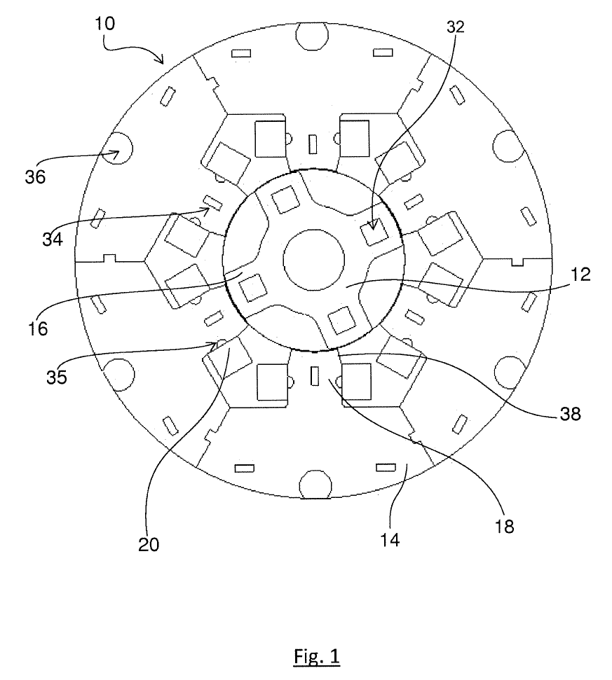

FIG. 1 diagrammatically shows a cross-section of an electric machine of a supercharger for an automotive vehicle; and

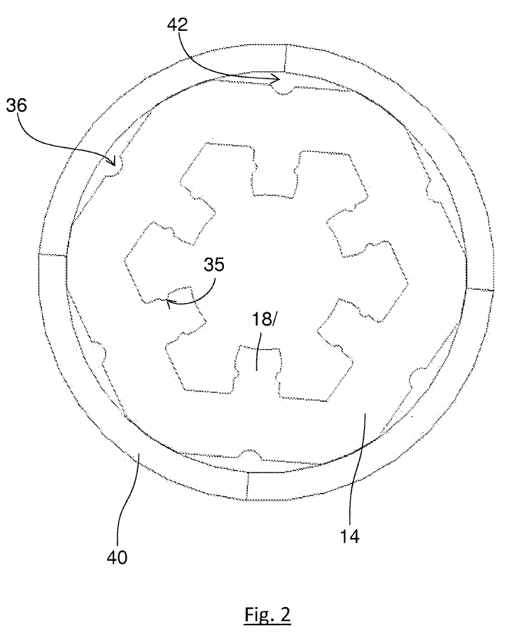

FIG. 2 schematically shows a cross-section of the stator/motor case assembly of an electric motor of a supercharger for an automotive vehicle.

In the rest of the description, elements that are identical or have an identical function bear the same reference sign in the various described embodiments. For concision of the present description, the identical elements or elements having an identical function are not described.

As illustrated in FIG. 1, an electric machine, and for example a variable reluctance or permanent-magnet electric motor 10, essentially comprises a rotor 12 and a stator 14. The rotor 12 here is mounted radially inside the stator 14. The rotor 12 and the stator 14 are made from a ferromagnetic metal. In particular, the stator here does not comprise a winding oriented along the longitudinal direction of the electric machine 10. The rotor 12 has radial teeth 16 (hereinafter called rotor teeth 16), oriented radially outward; here, there are four. The rotor teeth 16 are evenly angularly distributed. The stator 14 has teeth 18 (hereinafter called stator teeth 18) that are also radial, oriented in the direction opposite the teeth 16 of the rotor 12. Traditionally, there are more stator teeth 18 than there are rotor teeth 16. In the case at hand, the stator 14 has six stator teeth 18. The stator teeth 18 are evenly angularly distributed. Each of the stator teeth 18 is surrounded by a winding 20 or phase winding. When two opposite (or symmetrical) windings 20 are supplied with electricity, they form electromagnets and cause the rotor 12 to rotate in order to align the rotor teeth 16 with the stator teeth 18 surrounded by the windings 20 supplied with electricity. By successively commanding the power supply of pairs of opposite windings 20, the rotor 12 is rotated, the torque being produced by the tendency of the rotor to position itself such that the reluctance between a stator tooth and a rotor tooth is minimal, i.e., such that the air gap between these rotor and stator teeth is minimal.

Here, however, the rotor 12 and the stator 14 have cavities 32, 34, 35, 36, respectively, separate from the space between the rotor teeth 16 and between the stator teeth 18. These cavities 32, 34, 36 in particular make it possible to reduce the rigidity of the rotor 12 and/or the stator 14, which makes it possible to limit the noise emitted by the electric machine, and for example the variable reluctance or permanent-magnet motor, and/or to lower the emission frequencies of these noises. For ease of manufacturing and to limit the influence of the cavities 32, 34 on the torque exerted on the rotor 12, they are made in the rotor 16 and stator 18 teeth, respectively, and only emerge at the two end faces of the rotor 12 and the stator 14.

The stator 14 also has, on its radially outer face, cavities 36 that extend substantially along the longitudinal direction of the electric machine 10 and that emerge at two end faces of the stator 14 and on its radially outer surface. These cavities 36 thus have a groove shape. These cavities 36 also make it possible to damp the acoustic waves created by the motor, lowering both the frequency of these waves and their amplitude.

The stator teeth 18 also have, on their profile surfaces joining the base of the stator teeth 18 at their apex, cavities 35 also assuming the form of a groove here. These cavities 35 also make it possible to reduce the rigidity of the stator teeth 18.

Here as well, the stator teeth 18 have a bevel 38, in cross-section. In other words, the profile of the stator teeth 18 here has a first part with two parallel sides, connected to the apex of the stator teeth 18 by inclined surfaces relative to the two parallel sides of the first part of the profile. The incline angle of the surfaces (or bevel angle) can in particular be greater than 1°, still more preferably greater than 3°, and less than 10°, still more preferably less than 7°. These bevels 38 make it possible to limit the amplitude of the magnetic flux variations when the rotor teeth 16 align with the stator teeth 18. Indeed, due to the presence of the bevels 38, this variation in the magnetic flux is less abrupt, which makes it possible to limit the noise emitted by the electric machine, and for example the variable reluctance or permanent-magnet motor 10, by limiting the amplitude of the created sound waves. Alternatively, such bevels can be provided only on the rotor 12 or on both the rotor 12 and the stator 14.

An electric machine, and for example a variable reluctance or permanent-magnet motor 10, as described above, can be implemented in many applications in an automotive vehicle. In particular, it can be implemented for a traction motor system.

According to one particularly interesting application, however, the electric machine, and for example the variable reluctance or permanent-magnet electric motor as described above, can be implemented in an electric supercharger for an automotive vehicle, including a compression wheel rotated by the rotation of the rotor of the machine.

According to one alternative of the electric machine partially shown in FIG. 2 able to be implemented, for example, in an electric supercharger for an automotive vehicle, the stator 14 is received in a case 40 of the machine while leaving free spaces 42 between the stator 14 and the case 40.

Here, this is done first using a stator 14 having an outer enclosure with a generally polygonal shape, in cross-section, having several cutouts formed by the cavities 36 emerging on the radially outer face of the stator 14 and rounded corners intended to be in contact with the case 40 of the machine. The case 40 of the machine also defines a housing for receiving the stator having a substantially circular cross-section. Thus, with the rotor 14 inserted in the case 40, spaces 42 are kept free between the stator 14 and the case 40 that extend essentially over the entire length of the stator 14.

The stator 14 and the case 40 of the machine then define smaller contact zones, in particular linear contact zones, extending essentially along the longitudinal direction of the machine. These limited contact zones, in particular linear, make it possible to limit the propagation of the noise created in the motor outside the latter, via the case 40.

The invention is not limited solely to the example embodiments described above in light of the figures, as an illustrative and non-limiting example, and many alternatives are accessible to those skilled in the art.

1. An electric machine for use in a variable reluctance or permanent-magnet electric motor for an automotive vehicle, comprising:
a rotor; and
a stator provided with teeth,
the stator having at least one cavity separate from a space between the teeth of the stator and separate from a plurality of cavities extending along the longitudinal direction of the rotor being formed in the teeth of the rotor.

2. The electric machine according to claim 1, wherein the at least one cavity of the stator emerges only at one or both ends of the stator.

3. The electric machine according to claim 1, wherein the at least one cavity of the stator emerges on the radially outer surface of the stator in the form of a groove formed in the radially outer surface of the stator.

4. The electric machine according to claim 1, wherein the stator comprises at least one second cavity on a profile of a tooth of the stator, in the form of a groove formed in the profile surface of the tooth of the stator.

5. The electric machine according to claim 1, wherein the stator is received in a case of the machine while leaving free spaces between the stator and the case, the free spaces extending along a longitudinal direction of the stator, the stator and the case of the machine defining linear contact zones.

6. The electric machine according to claim 5, wherein the stator has, in cross-section, a generally polygonal enclosure having one or several cutouts formed by at least one cavity emerging on the radially outer surface of the stator, and rounded corners configured to be in contact with the case of the machine.

7. The electric machine according to claim 6, wherein the case of the machine forms a housing for receiving the stator that is generally circular in cross-section.

8. The electric machine according to claim 1, wherein the teeth of the stator and/or the teeth of the rotor have, in cross-section, bevels preferably forming an angle greater than 3°, and less than 7°.

9. An electric supercharger for an automotive vehicle, comprising:
a compression wheel; and
an electric machine according to claim 1, to rotate the compression wheel.
